(19) United States
(12) Patent Application Publication
(10) Pub. No.: US 2026/0249371 A1
(43) Pub. Date: Aug. 27, 2026

(54) SELF-CENTERING CLAMPING FIXTURE FOR HIGH-PERFORMANCE THIN-WEB GEAR

(71) Applicant: Harbin Institute of Technology, Harbin (CN)

(72) Inventor: Guangbin Yu, Harbin (CN)

(21) Appl. No.: 19/648,913

(22) Filed: Apr. 15, 2026

(30) Foreign Application Priority Data
Jan. 7, 2026 (CN) 202610015313.7

(51) Int. Cl. B23F 23/06

(52) U.S. Cl. CPC B23F 23/06

(57) ABSTRACT

The present application discloses a self-centering clamping fixture for a high-performance thin-web gear. The self-centering clamping fixture for a high-performance thin-web gear includes a base, a movable clamping mechanism, and a self-centering mechanism. The movable clamping mechanism includes an I-shaped slider, a right-angle push plate is fixedly installed at a bottom portion of the I-shaped slider, and a clamping head is installed at a top portion of the I-shaped slider. The self-centering mechanism includes a guiding assembly and a centering assembly. The guiding assembly includes a six-claw bracket, a feed tray is fixedly installed at a top portion of the six-claw bracket, and an arc-shaped guiding hole is formed on a top portion of the feed tray. The centering assembly includes a cylindrical base sleeve, and a cylindrical housing is rotatably installed at a center of the cylindrical base sleeve.

### CROSS-REFERENCE TO RELATED APPLICATIONS

This application claims priority to Chinese Patent Application No. CN202610015313.7, filed on January 07, 2026, which is hereby incorporated by reference in its entirety.

### TECHNICAL FIELD

The present application relates to the field of clamping technology, and specifically, to a self-centering clamping fixture for a high-performance thin-web gear.

### BACKGROUND

A high-performance thin-web gear is a special structural gear developed in the field of gears to meet the requirements of lightweight, high precision, and high rigidity, and the core feature of the thin-web gear is that a thickness of the web is less than that of conventional gears. The weight reduction and performance balance are achieved by optimizing the web structure. The high-performance thin-web gear is widely applied in scenarios with stringent requirements on weight, space, and transmission efficiency, such as aerospace, new energy vehicles, precision transmission, and robotics. Before machining a high-performance thin-web gear, the high-performance thin-web gear requires clamping and positioning for fixation. A clamping fixture is required to ensure machining accuracy and stability.

Currently, during conventional clamping of a high-performance thin-web gear, self-centering is inconvenient, and eccentricity easily occurs, affecting subsequent machining accuracy of the high-performance thin-web gear.

### SUMMARY

To solve the above technical problems, the present application provides the following technical solution:

A self-centering clamping fixture for a high-performance thin-web gear includes:

a base, and a hydraulic cylinder fixedly installed at a lateral edge of a surface of the base, where a strip-shaped slot is formed at a lateral edge of a top portion of the base, and an auxiliary mechanism is installed at a middle position of a top portion of an inner cavity of the base;

a movable clamping mechanism, where the movable clamping mechanism includes an I-shaped slider, the I-shaped slider is slidably mounted on the top portion of the base through the strip-shaped slot, a right-angle push plate is fixedly installed at a bottom portion of the I-shaped slider, a clamping head is installed at a top portion of the I-shaped slider, a thrust is applied to the I-shaped slider by extending a retractable end of the hydraulic cylinder, to cause two symmetrically arranged I-shaped sliders to drive the clamping heads to move toward each other, facilitating clamping of a high-performance thin-web gear to be machined; a surface of the I-shaped slider is fitted with an inner surface of the strip-shaped slot, and under the thrust applied by the retractable end of the hydraulic cylinder, loosening is prevented, which is conducive to clamping the high-performance thin-web gear;

a self-centering mechanism, where the self-centering mechanism includes a guiding assembly and a centering assembly, the guiding assembly is fixedly installed at a middle position of the top portion of the base, and the centering assembly is installed at the top portion of the inner cavity of the base;

the guiding assembly includes a six-claw bracket, the six-claw bracket is fixedly installed at the middle position of the top portion of the base, a feed tray is fixedly installed at a top end of the six-claw bracket, and an arc-shaped guiding hole is formed at a top portion of the feed tray;

the centering assembly includes a cylindrical base sleeve, the cylindrical base sleeve is fixedly installed at the middle position of the top portion of the inner cavity of the base, a top end of the cylindrical base sleeve extends to the top portion of the base, a cylindrical housing is rotatably mounted at a center of the cylindrical base sleeve, a swinging arm is hingedly installed at a bottom portion of an inner cavity of the cylindrical housing, a centering round rod is fixedly installed at a lateral edge of a top portion of the swinging arm, and a top end of the centering round rod passes through an inner side of the arc-shaped guiding hole; a thrust is applied to a force-receiving plate by a tip of a bottom portion of the right-angle push plate, and a supporting column and the cylindrical housing rotate clockwise together under rotational support of the supporting column; a spiral spring plate elastically deforms under torque, and under hinged movable connection of the swinging arm, the centering round rod moves outward along the arc-shaped guiding hole; and with evenly distributed centering round rods expanding outward, surfaces of the centering round rods are fitted with an inner wall of a central hole of the high-performance thin-web gear, and a deflecting force is applied to the high-performance thin-web gear to move the high-performance thin-web gear to a middle position of the feed tray, thereby achieving self-centering.

Preferably, the retractable end of the hydraulic cylinder is fixedly mounted on a surface of the right-angle push plate, four strip-shaped slots are provided, and the four strip-shaped slots are evenly distributed at lateral edges of the top portion of the base.

Preferably, a surface of the I-shaped slider is fitted with the inner surface of the strip-shaped slot, two right-angle push plates are provided, and the two right-angle push plates are symmetrically mounted along a central axis at a middle position of the base.

Preferably, the clamping head includes a connecting beam, two ends of a surface of the connecting beam are fixedly mounted on the top portion of the I-shaped slider by screws, a rectangular seat is fixedly installed at a middle position of a top portion of the connecting beam, a clamping block is fixedly installed at a top portion of the rectangular seat on a side close to the feed tray, a damper is fixedly installed on a surface of the clamping block, and a retractable end of a surface of the damper is fixedly installed with a tooth-engaging block. As the I-shaped slider moves under the thrust applied by the retractable end of the hydraulic cylinder, and under support of the connecting beam and the rectangular seat, two symmetrically arranged clamping blocks move toward the center, and the tooth-engaging block is embedded between teeth on surfaces of two adjacent gears, so that the high-performance thin-web gear to be machined is limited. Furthermore, a clamping surface on an inner side of the clamping blocks contacts a surface of the high-performance thin-web gear to be machined, enabling clamping of the high-performance thin-web gear without tilting or displacement.

Preferably, the clamping block is arcuate, two clamping blocks are provided, the two clamping blocks are symmetrically mounted along the feed tray, and the tooth-engaging blocks are evenly distributed at clamping surfaces of the clamping blocks.

As the tooth-engaging blocks are embedded between teeth on surfaces of two adjacent gears, and as the clamping blocks continue to move, in combination with action force and reaction force, the tooth-engaging blocks are subjected to a reverse thrust from the gear. With contraction of a retractable end of the damper, the positions of the tooth-engaging blocks are finely adjusted, which enables flexible contact with the high-performance thin-web gear, avoiding rigid contact, and prevents damage to the high-performance thin-web gear, thereby providing protection.

Preferably, three arc-shaped guiding holes are provided, the three arc-shaped guiding holes are evenly distributed at the top portion of the feed tray, and the arc-shaped guiding holes penetrate the feed tray.

Preferably, the cylindrical housing is installed directly below the feed tray, the cylindrical housing and the cylindrical base sleeve are concentric, three swinging arms are provided, the three swinging arms are evenly distributed at the bottom portion of the inner cavity of the cylindrical housing, and the centering round rod is vertically installed. As the two symmetrically arranged right-angle push plates move outward, the thrust applied by the bottom ends of the right-angle push plates to the force-receiving plate disappears. Under the elastic force of the spiral spring plate, the supporting column drives the cylindrical housing to rotate in the opposite direction. Guided by the arc-shaped guiding holes, the centering round rod moves toward a center of the feed tray, causing the top end of the centering round rod to separate from the inner wall of the central hole of the high-performance thin-web gear, thereby facilitating unloading of the high-performance thin-web gear.

Preferably, the auxiliary mechanism includes a U-shaped frame, the U-shaped frame has an opening facing upward, a top end of the U-shaped frame is fixedly installed on the top portion of the inner cavity of the base by screws, a supporting column is rotatably mounted at a middle position of a bottom portion of an inner cavity of the U-shaped frame, a top end of the supporting column is fixedly installed with a bottom portion of the cylindrical housing, a spiral spring plate is fixedly installed between an outer circumferential surface of the supporting column and an inner surface of the U-shaped frame, a bottom portion of the outer circumferential surface of the supporting column is fixedly connected with a force-receiving plate, and an end of a surface of the force-receiving plate away from the supporting column is fixedly connected with a limiting clamping plate. As two symmetrically arranged right-angle push plates move toward each other, tips at bottom portions of the right-angle push plates contact the surface of the force-receiving plate, and the limiting clamping plate on the surface of the force-receiving plate is positioned above and below the tips at the bottom portions of the right-angle push plates, thereby limiting the tips at the bottom portions of the right-angle push plates and preventing slippage when the thrust is applied to the force-receiving plate by the tips at the bottom portions of the right-angle push plates.

Preferably, an axis of the supporting column coincides with a central axis of the cylindrical housing, and the supporting column is vertically installed.

Preferably, the supporting column passes through a center of the spiral spring plate, the force-receiving plate and the bottom portions of the right-angle push plates are installed at the same height, two force-receiving plates are provided, and the two force-receiving plates are symmetrically mounted along a central axis of the supporting column.

The present application provides a self-centering clamping fixture for a high-performance thin-web gear. The self-centering clamping fixture for the high-performance thin-web gear has the following beneficial effects:

1. According to the self-centering clamping fixture for the high-performance thin-web gear, by extension of the retractable end of the hydraulic cylinder, a thrust can be applied to the I-shaped sliders, so that the two symmetrically arranged I-shaped sliders drive the clamping head to move toward each other as a whole, which facilitates clamping of the high-performance thin-web gear to be machined. The surfaces of the I-shaped sliders are fitted with inner surfaces of the strip-shaped slots, and under the thrust applied by the retractable end of the hydraulic cylinder, loosening is unlikely to occur, thereby assisting in clamping the high-performance thin-web gear.

2. According to the self-centering clamping fixture for the high-performance thin-web gear, as the I-shaped sliders move under the thrust applied by the retractable end of the hydraulic cylinder and under support of the connecting beam and the rectangular seat, the two symmetrically arranged clamping blocks move toward the center. The tooth-engaging blocks are embedded between teeth on surfaces of two adjacent gears, so that the high-performance thin-web gear to be machined is limited. The clamping surfaces on inner sides of the clamping blocks contact the surface of the high-performance thin-web gear to be machined, enabling clamping of the high-performance thin-web gear without tilting or displacement.

3. According to the self-centering clamping fixture for the high-performance thin-web gear, as the tooth-engaging blocks are embedded between teeth on surfaces of two adjacent gears, and as the clamping blocks continue to move, in combination with action force and reaction force, the tooth-engaging blocks are subjected to a reverse thrust from the gear. With contraction of a retractable end of the damper, the positions of the tooth-engaging blocks are finely adjusted, which enables flexible contact with the high-performance thin-web gear, avoiding rigid contact, and prevents damage to the high-performance thin-web gear, thereby providing protection.

4. According to the self-centering clamping fixture for the high-performance thin-web gear, the tips at the bottom portions of the right-angle push plates contact the surface of the force-receiving plate, and the limiting clamping plate on the surface of the force-receiving plate is positioned above and below the tips at the bottom portions of the right-angle push plates, thereby limiting the tips at the bottom portions of the right-angle push plates and preventing slippage when the thrust is applied to the force-receiving plate by the tips at the bottom portions of the right-angle push plates.

5. According to the self-centering clamping fixture for the high-performance thin-web gear, with the thrust applied by the tip of the bottom portion of the right-angle push plate to the force-receiving plate and under rotational support of the supporting column, the supporting column and the cylindrical housing rotate clockwise together. The spiral spring plate is elastically deformed under torque, and under hinged connection of the swinging arms, the centering round rods move outward along the arc-shaped guiding holes. As the centering round rods evenly distributed move outward, surfaces of the centering round rods contact inner walls of the central hole of the high-performance thin-web gear, applying a deflecting force to move the high-performance thin-web gear to the middle position of the feed tray, thereby achieving self-centering.

6. According to the self-centering clamping fixture for the high-performance thin-web gear, as the two symmetrically arranged right-angle push plates move outward, a thrust from the bottom ends of the right-angle push plates on the force-receiving plates disappears. Under elastic force of the spiral spring plates, the supporting column drives the cylindrical housing to rotate in the opposite direction. Guided by the arc-shaped guiding holes, the centering round rods move toward the center of the feed tray, so that the top ends of the centering round rods separate from the inner walls of the central hole of the high-performance thin-web gear, facilitating unloading of the high-performance thin-web gear.

### BRIEF DESCRIPTION OF DRAWINGS

FIG. 1 is a schematic diagram of an overall structure of a self-centering clamping fixture for a high-performance thin-web gear according to the present application;

FIG. 2 is a schematic diagram of a bottom-view structure of a self-centering clamping fixture for a high-performance thin-web gear according to the present application;

FIG. 3 is a schematic diagram of a connection structure among a movable clamping mechanism, a self-centering mechanism, and a base according to the present application;

FIG. 4 is a schematic diagram of an overall structure of a movable clamping mechanism according to the present application;

FIG. 5 is a schematic diagram of a disassembled structure between a guiding assembly and a centering assembly according to the present application;

FIG. 6 is a schematic diagram of an overall structure of a centering assembly according to the present application;

FIG. 7 is a schematic diagram of a connection structure between an auxiliary mechanism and a base according to the present application; and

FIG. 8 is a schematic diagram of an overall structure of an auxiliary mechanism according to the present application.

Reference numerals: 1. base; 2. hydraulic cylinder; 3. strip-shaped slot; 4. auxiliary mechanism; 5. movable clamping mechanism; 6. self-centering mechanism; 41. U-shaped frame; 42. supporting column; 43. spiral spring plate; 44. force-receiving plate; 45. limiting clamping plate; 51. I-shaped slider; 52. right-angle push plate; 53. clamping head; 531. connecting beam; 532. rectangular seat; 533. clamping block; 534. damper; 535. tooth-engaging block; 61. guiding assembly; 62. centering assembly; 611. six-claw bracket; 612. feed tray; 613. arc-shaped guiding hole; 621. cylindrical base sleeve; 622. cylindrical housing; 623. swinging arm; and 624. centering round rod.

### DESCRIPTION OF EMBODIMENTS

The following clearly and completely describes the technical solutions in embodiments of the present application with reference to the accompanying drawings in embodiments of the present application. It is clear that the described embodiments are merely a part rather than all of embodiments of the present application. Based on the embodiments of the present application, all other embodiments obtained by those of ordinary skill in the art without creative effort fall within the protection scope of the present application.

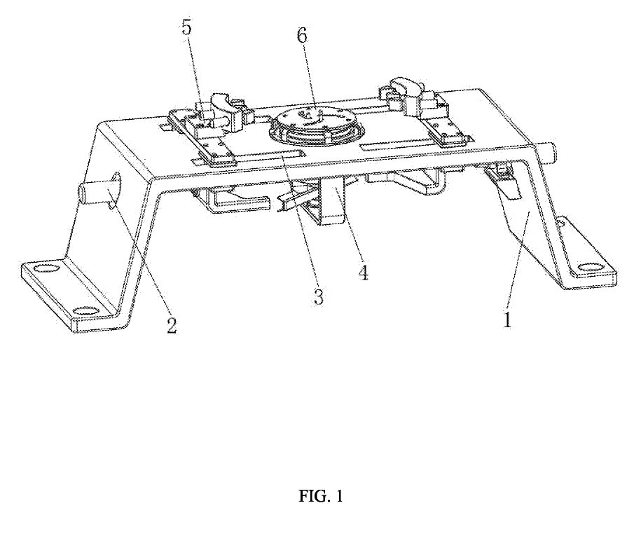

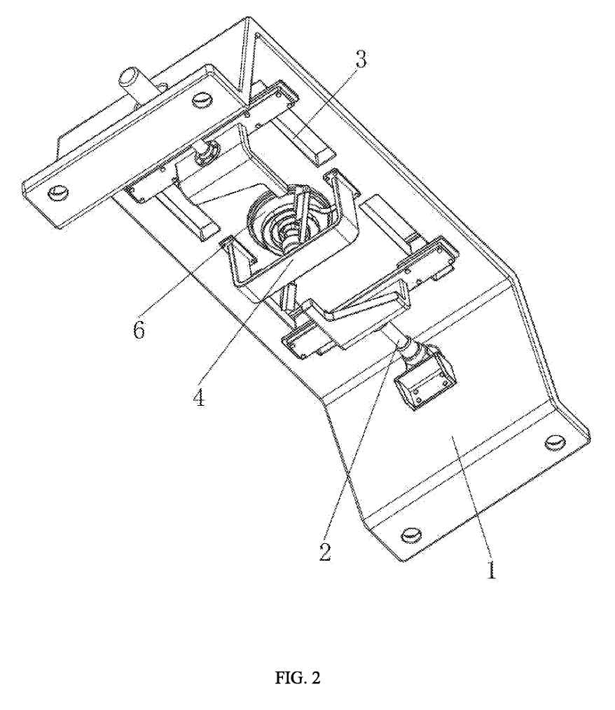

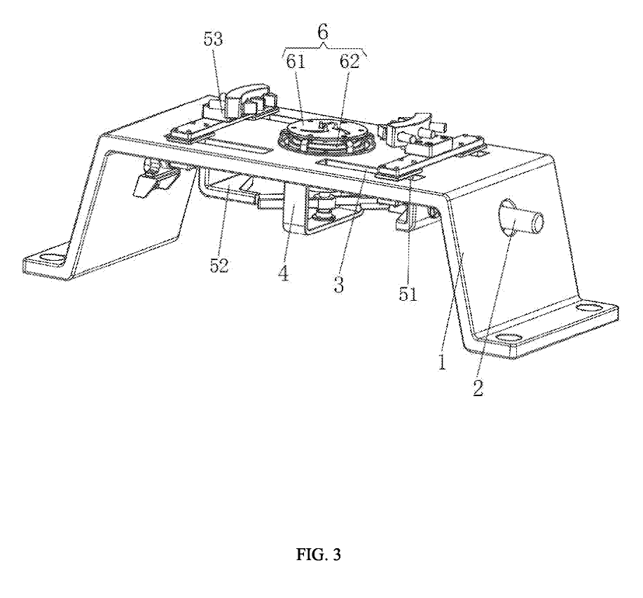

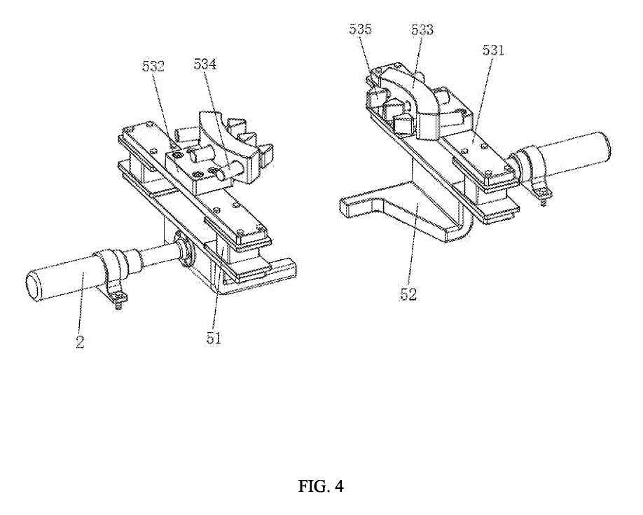

Embodiment 1: Referring to FIGS. 1 to 4, the present application provides a technical solution:

A self-centering clamping fixture for a high-performance thin-web gear includes:

a base 1, and a hydraulic cylinder 2 fixedly installed at a lateral edge of a surface of the base 1, where a strip-shaped slot 3 is formed at a lateral edge of a top portion of the base 1, and an auxiliary mechanism 4 is installed at a middle position of a top portion of an inner cavity of the base 1;

a movable clamping mechanism 5, where the movable clamping mechanism 5 includes an I-shaped slider 51, the I-shaped slider 51 is slidably mounted on the top portion of the base 1 through the strip-shaped slot 3, a right-angle push plate 52 is fixedly installed at a bottom portion of the I-shaped slider 51, and a clamping head 53 is installed at a top portion of the I-shaped slider 51; the clamping fixture is installed at a designated position of the high-performance thin-web gear machining equipment through support by the base 1, and the hydraulic cylinder 2 is activated for operation; a thrust is applied to the I-shaped slider 51 by extending a retractable end of the hydraulic cylinder 2, to cause two symmetrically arranged I-shaped sliders 51 to drive the clamping heads 53 to move toward each other, facilitating clamping of a high-performance thin-web gear to be machined; a surface of the I-shaped slider 51 is fitted with an inner surface of the strip-shaped slot 3, and under the thrust applied by the retractable end of the hydraulic cylinder 2, loosening is prevented, which is conducive to clamping the high-performance thin-web gear; and

the retractable end of the hydraulic cylinder 2 is fixedly mounted on a surface of the right-angle push plate 52, four strip-shaped slots 3 are provided, and the four strip-shaped slots 3 are evenly distributed at lateral edges of the top portion of the base 1.

A surface of the I-shaped slider 51 is fitted with the inner surface of the strip-shaped slot 3, two right-angle push plates 52 are provided, and the two right-angle push plates 52 are symmetrically mounted along a central axis at a middle position of the base 1.

The clamping head 53 includes a connecting beam 531, two ends of a surface of the connecting beam 531 are fixedly mounted on the top portion of the I-shaped slider 51 by screws, a rectangular seat 532 is fixedly installed at a middle position of a top portion of the connecting beam 531, a clamping block 533 is fixedly installed at a top portion of the rectangular seat 532 on a side close to the feed tray 612, a damper 534 is fixedly installed on a surface of the clamping block 533, and a retractable end of a surface of the damper 534 is fixedly installed with a tooth-engaging block 535. As the I-shaped slider 51 moves under the thrust applied by the retractable end of the hydraulic cylinder 2, and under support of the connecting beam 531 and the rectangular seat 532, two symmetrically arranged clamping blocks 533 move toward the center, and the tooth-engaging block 535 is embedded between teeth on surfaces of two adjacent gears, so that the high-performance thin-web gear to be machined is limited. Furthermore, a clamping surface on an inner side of the clamping blocks 533 contacts a surface of the high-performance thin-web gear to be machined, enabling clamping of the high-performance thin-web gear without tilting or displacement.

The clamping block 533 is arcuate, two clamping blocks 533 are provided, the two clamping blocks 533 are symmetrically mounted along the feed tray 612, and the tooth-engaging blocks 535 are evenly distributed at clamping surfaces of the clamping blocks 533. As the tooth-engaging blocks 535 are embedded between teeth on surfaces of two adjacent gears, and as the clamping blocks 533 continue to move, in combination with action force and reaction force, the tooth-engaging blocks 535 are subjected to a reverse thrust from the gear. With contraction of a retractable end of the damper 534, the positions of the tooth-engaging blocks 535 are finely adjusted, which enables flexible contact with the high-performance thin-web gear, avoiding rigid contact, and prevents damage to the high-performance thin-web gear, thereby providing protection.

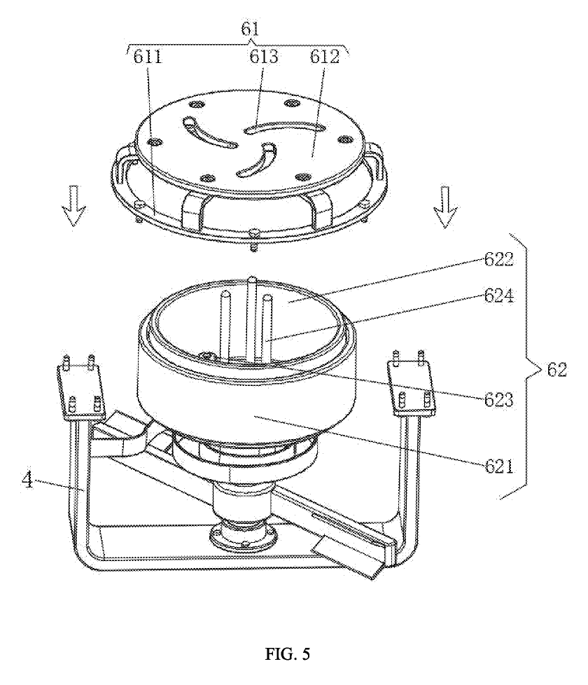

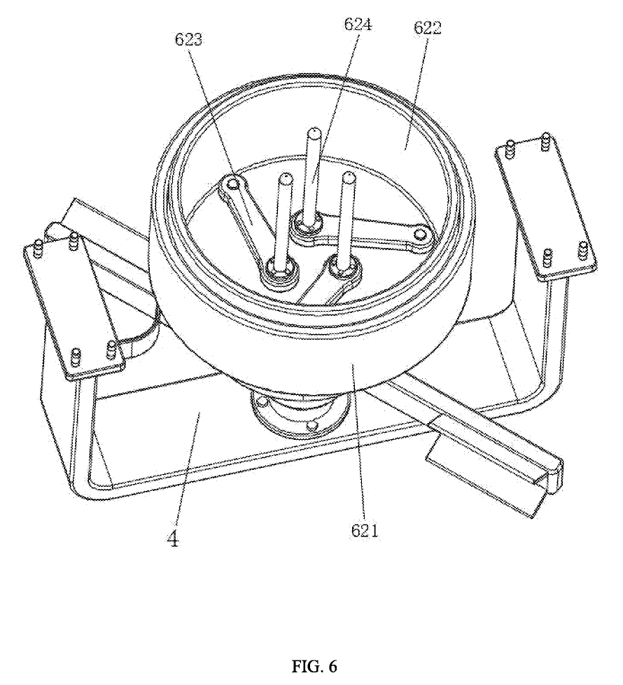

Embodiment 2: Based on Embodiment 1, referring to FIGS. 1-6:

The auxiliary mechanism 4 includes a U-shaped frame 41, the U-shaped frame 41 has an opening facing upward, a top end of the U-shaped frame 41 is fixedly installed on the top portion of the inner cavity of the base 1 by screws, a supporting column 42 is rotatably mounted at a middle position of a bottom portion of an inner cavity of the U-shaped frame 41, a top end of the supporting column 42 is fixedly installed with a bottom portion of a cylindrical housing 622, a spiral spring plate 43 is fixedly installed between an outer circumferential surface of the supporting column 42 and an inner surface of the U-shaped frame 41, a bottom portion of the outer circumferential surface of the supporting column 42 is fixedly connected with a force-receiving plate 44, and an end of a surface of the force-receiving plate 44 away from the supporting column 42 is fixedly connected with a limiting clamping plate 45.

The self-centering clamping fixture for the high-performance thin-web gear further includes: a movable clamping mechanism 5, where the movable clamping mechanism 5 includes an I-shaped slider 51, the I-shaped slider 51 is slidably mounted on the top portion of the base 1 through the strip-shaped slot 3, a right-angle push plate 52 is fixedly installed at a bottom portion of the I-shaped slider 51, and a clamping head 53 is installed at a top portion of the I-shaped slider 51; and

a self-centering mechanism 6, where the self-centering mechanism 6 includes a guiding assembly 61 and a centering assembly 62, the guiding assembly 61 is fixedly installed at a middle position of a top portion of the base 1, and the centering assembly 62 is installed at a top portion of the inner cavity of the base 1.

The guiding assembly 61 includes a six-claw bracket 611, the six-claw bracket 611 is fixedly installed at the middle position of the top portion of the base 1, a feed tray 612 is fixedly installed at a top end of the six-claw bracket 611, and an arc-shaped guiding hole 613 is formed at a top portion of the feed tray 612.

Three arc-shaped guiding holes 613 are provided, the three arc-shaped guiding holes 613 are evenly distributed at the top portion of the feed tray 612, and the arc-shaped guiding holes 613 penetrate the feed tray 612.

The centering assembly 62 includes a cylindrical base sleeve 621, the cylindrical base sleeve 621 is fixedly installed at the middle position of the top portion of the inner cavity of the base 1, a top end of the cylindrical base sleeve 621 extends to the top portion of the base 1, a cylindrical housing 622 is rotatably mounted at a center of the cylindrical base sleeve 621, a swinging arm 623 is hingedly installed at a bottom portion of an inner cavity of the cylindrical housing 622, a centering round rod 624 is fixedly installed at a lateral edge of a top portion of the swinging arm 623, and a top end of the centering round rod 624 passes through an inner side of the arc-shaped guiding hole 613; a thrust is applied to the force-receiving plate 44 by a tip of a bottom portion of the right-angle push plate 52, and a supporting column 42 and the cylindrical housing 622 rotate clockwise together under rotational support of the supporting column 42; a spiral spring plate 43 elastically deforms under torque, and under hinged movable connection of the swinging arm 623, the centering round rod 624 moves outward along the arc-shaped guiding hole 613; and with evenly distributed centering round rods 624 expanding outward, surfaces of the centering round rods 624 are fitted with an inner wall of a central hole of the high-performance thin-web gear, and a deflecting force is applied to the high-performance thin-web gear to move the high-performance thin-web gear to a middle position of the feed tray 612, thereby achieving self-centering.

The cylindrical housing 622 is installed directly below the feed tray 612, the cylindrical housing 622 and the cylindrical base sleeve 621 are concentric, three swinging arms 623 are provided, the three swinging arms 623 are evenly distributed at a bottom portion of an inner cavity of the cylindrical housing 622, and the centering round rods 624 are vertically installed. As the two symmetrically arranged right-angle push plates 52 move outward, the thrust applied by the bottom ends of the right-angle push plates 52 to the force-receiving plate 44 disappears. Under the elastic force of the spiral spring plate 43, the supporting column 42 drives the cylindrical housing 622 to rotate in the opposite direction. Guided by the arc-shaped guiding holes 613, the centering round rod 624 moves toward a center of the feed tray 612, causing the top end of the centering round rod 624 to separate from the inner wall of the central hole of the high-performance thin-web gear, thereby facilitating unloading of the high-performance thin-web gear.

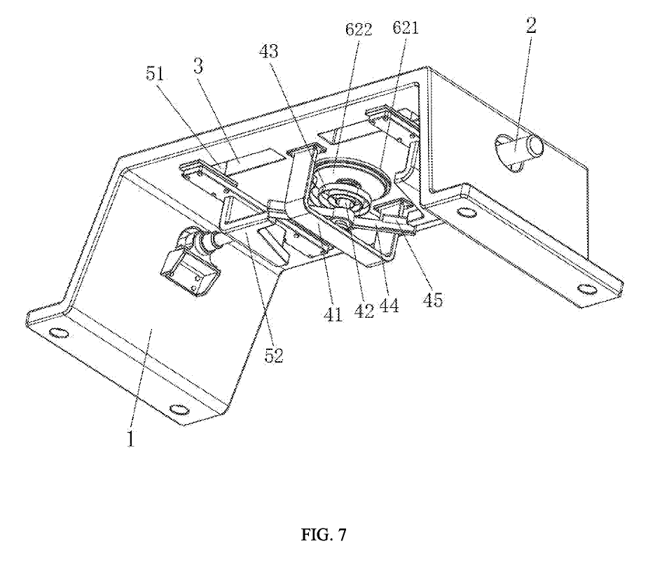

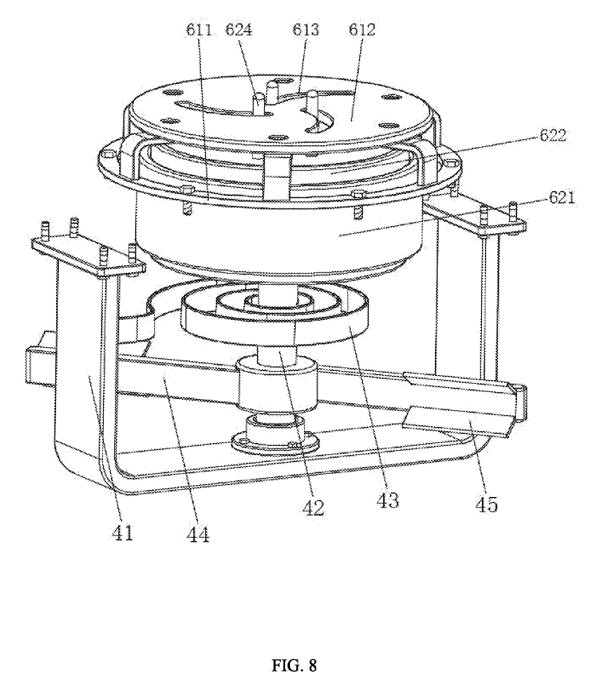

Embodiment 3: Based on Embodiment 1 and Embodiment 2, referring to FIGS. 1-8:

An axis of the supporting column 42 coincides with a central axis of the cylindrical housing 622, and the supporting column 42 is vertically installed.

The supporting column 42 passes through the center of the spiral spring plate 43, the force-receiving plate 44 is installed at the same height as the bottom portions of the right-angle push plates 52, two force-receiving plate 44 are provided, the two force-receiving plates 44 are symmetrically mounted along a central axis of the supporting column 42. As the two symmetrically arranged right-angle push plates 52 move toward each other, the tips at the bottom portions of the right-angle push plates 52 contact the surfaces of the force-receiving plates 44, and the limiting clamping plates 45 on the surfaces of the force-receiving plates 44 are located above and below the tips at the bottoms of the right-angle push plates 52. The tips at the bottom portions of the right-angle push plates 52 can thus be restricted, so that when the thrust is applied to the force-receiving plates 44 by the tips at the bottom portions of the right-angle push plates 52, slippage is unlikely to occur.

During use, the self-centering clamping fixture is first installed at a designated position of the high-performance thin-web gear machining equipment through support by the base 1.

In the initial state, three centering round rods 624 evenly distributed are gathered together, and the high-performance thin-web gear to be machined is placed on the top portion of the feed tray 612, with the tips of the centering round rods 624 passing through the central hole of the high-performance thin-web gear.

In this case, the operator activates the hydraulic cylinder 2 for operation. By extension of the retractable end of the hydraulic cylinder 2, a thrust is applied to the I-shaped sliders 51, so that the two symmetrically arranged I-shaped sliders 51 drive the clamping head 53 to move toward each other as a whole.

Simultaneously, as the two symmetrically arranged right-angle push plates 52 move toward each other, the tips at the bottom portions of the right-angle push plates 52 contact the surfaces of the force-receiving plates 44, and the limiting clamping plates 45 on the surfaces of the force-receiving plates 44 are located above and below the tips at the bottom portions of the right-angle push plates 52, thereby limiting the tips at the bottom portions of the right-angle push plates 52 and preventing slippage when the thrust is applied to the force-receiving plate 44 by the tips at the bottom portions of the right-angle push plates 52.

With the thrust applied by the tips of the bottom portions of the right-angle push plates 52 to the force-receiving plates 44 and under rotational support of the supporting column 42, the supporting column 42 and the cylindrical housing 622 rotate clockwise together. The spiral spring plate 43 is elastically deformed under torque, and under hinged connection of the swinging arms 623, the centering round rods 624 move outward along the arc-shaped guiding holes 613. As the centering round rods 624 evenly distributed move outward, surfaces of the centering round rods 624 contact inner walls of the central hole of the high-performance thin-web gear, applying a deflecting force to move the high-performance thin-web gear to the middle position of the feed tray 612, thereby achieving self-centering.

In addition, as the I-shaped sliders 51 move under the thrust applied by the retractable end of the hydraulic cylinder 2 and under support of the connecting beam 531 and the rectangular seat 532, the two symmetrically arranged clamping blocks 533 move toward the center. The tooth-engaging blocks 535 are embedded between teeth on surfaces of two adjacent gears, so that the high-performance thin-web gear to be machined is limited. The clamping surfaces on inner sides of the clamping blocks 533 contact the surface of the high-performance thin-web gear to be machined, enabling clamping of the high-performance thin-web gear without tilting or displacement.

As the tooth-engaging blocks 535 are embedded between teeth on surfaces of two adjacent gears, and as the clamping blocks 533 continue to move, in combination with action force and reaction force, the tooth-engaging blocks 535 are subjected to a reverse thrust from the gear. With contraction of a retractable end of the damper 534, the positions of the tooth-engaging blocks 535 are finely adjusted, which enables flexible contact with the high-performance thin-web gear, avoiding rigid contact, and prevents damage to the high-performance thin-web gear, thereby providing protection.

When the machining of the high-performance thin-web gear is completed, and the two symmetrically arranged right-angle push plates 52 move outward, the thrust applied by the bottom ends of the right-angle push plates 52 to the force-receiving plate 44 disappears. Under the elastic force of the spiral spring plate 43, the supporting column 42 drives the cylindrical housing 622 to rotate in the opposite direction. Guided by the arc-shaped guiding holes 613, the centering round rod 624 moves toward a center of the feed tray 612, causing the top end of the centering round rod 624 to separate from the inner wall of the central hole of the high-performance thin-web gear, thereby facilitating unloading of the high-performance thin-web gear.

It should be noted that, as used herein, terms such as "first" and "second," among other relational terms, are merely used to distinguish one entity or operation from another, and do not necessarily require or imply any actual relationship or sequence between these entities or operations. In addition, the terms "include", "comprise", or any other variants thereof used herein are intended to cover a non-exclusive inclusion, so that a process, a method, an article or a device that includes a list of elements includes those elements, and also includes other elements which are not expressly listed, or further includes elements inherent to this process, method, article or device. Without further limitation, an element defined by the phrase "including a/an…" does not exclude the presence of another identical element in the process, method, article or device that includes the element.

Although embodiments of the present application have been shown and described, it will be understood by those of ordinary skill in the art that various changes, modifications, substitutions, and variations can be made to these embodiments without departing from the principles and spirit of the present application. The scope of the present application is defined by the appended claims and equivalents thereof.

What is claimed is:

1. A self-centering clamping fixture for a high-performance thin-web gear, comprising:
a base, and a hydraulic cylinder fixedly installed at a lateral edge of a surface of the base, wherein a strip-shaped slot is formed at a lateral edge of a top portion of the base, and an auxiliary mechanism is installed at a middle position of a top portion of an inner cavity of the base;
a movable clamping mechanism, wherein the movable clamping mechanism comprises an I-shaped slider, the I-shaped slider is slidably mounted on the top portion of the base through the strip-shaped slot, a right-angle push plate is fixedly installed at a bottom portion of the I-shaped slider, and a clamping head is installed at a top portion of the I-shaped slider; and
a self-centering mechanism, wherein the self-centering mechanism comprises a guiding assembly and a centering assembly, the guiding assembly is fixedly installed at a middle position of the top portion of the base, and the centering assembly is installed at the top portion of the inner cavity of the base;
the guiding assembly comprises a six-claw bracket, the six-claw bracket is fixedly installed at the middle position of the top portion of the base, a feed tray is fixedly installed at a top end of the six-claw bracket, and an arc-shaped guiding hole is formed at a top portion of the feed tray;
the centering assembly comprises a cylindrical base sleeve, the cylindrical base sleeve is fixedly installed at the middle position of the top portion of the inner cavity of the base, a top end of the cylindrical base sleeve extends to the top portion of the base, a cylindrical housing is rotatably mounted at a center of the cylindrical base sleeve, a swinging arm is hingedly installed at a bottom portion of an inner cavity of the cylindrical housing, a centering round rod is fixedly installed at a lateral edge of a top portion of the swinging arm, and a top end of the centering round rod passes through an inner side of the arc-shaped guiding hole; and
the auxiliary mechanism comprises a U-shaped frame, the U-shaped frame has an opening facing upward, a top end of the U-shaped frame is fixedly installed on the top portion of the inner cavity of the base by screws, a supporting column is rotatably mounted at a middle position of a bottom portion of an inner cavity of the U-shaped frame, a top end of the supporting column is fixedly installed with a bottom portion of the cylindrical housing, a spiral spring plate is fixedly installed between an outer circumferential surface of the supporting column and an inner surface of the U-shaped frame, a bottom portion of the outer circumferential surface of the supporting column is fixedly connected with a force-receiving plate, and an end of a surface of the force-receiving plate away from the supporting column is fixedly connected with a limiting clamping plate.

2. The self-centering clamping fixture for a high-performance thin-web gear according to claim 1, wherein a retractable end of the hydraulic cylinder is fixedly mounted on a surface of the right-angle push plate, four strip-shaped slots are provided, and the four strip-shaped slots are evenly distributed at lateral edges of the top portion of the base.

3. The self-centering clamping fixture for a high-performance thin-web gear according to claim 1, wherein a surface of the I-shaped slider is fitted with an inner surface of the strip-shaped slot, two right-angle push plates are provided, and the two right-angle push plates are symmetrically mounted along a central axis at a middle position of the base.

4. The self-centering clamping fixture for a high-performance thin-web gear according to claim 1, wherein the clamping head comprises a connecting beam, two ends of a surface of the connecting beam are fixedly mounted on the top portion of the I-shaped slider by screws, a rectangular seat is fixedly installed at a middle position of a top portion of the connecting beam, a clamping block is fixedly installed at a top portion of the rectangular seat on a side close to the feed tray, a damper is fixedly installed on a surface of the clamping block, and a retractable end of a surface of the damper is fixedly installed with a tooth-engaging block.

5. The self-centering clamping fixture for a high-performance thin-web gear according to claim 4, wherein the clamping block is arcuate, two clamping blocks are provided, the two clamping blocks are symmetrically mounted along the feed tray, and the tooth-engaging blocks are evenly distributed at clamping surfaces of the clamping blocks.

6. The self-centering clamping fixture for a high-performance thin-web gear according to claim 1, wherein three arc-shaped guiding holes are provided, the three arc-shaped guiding holes are evenly distributed at the top portion of the feed tray, and the arc-shaped guiding holes penetrate the feed tray.

7. The self-centering clamping fixture for a high-performance thin-web gear according to claim 1, wherein the cylindrical housing is installed directly below the feed tray, the cylindrical housing and the cylindrical base sleeve are concentric, three swinging arms are provided, the three swinging arms are evenly distributed at the bottom portion of the inner cavity of the cylindrical housing, and the centering round rod is vertically installed.

8. The self-centering clamping fixture for a high-performance thin-web gear according to claim 1, wherein an axis of the supporting column coincides with a central axis of the cylindrical housing, and the supporting column is vertically installed.

9. The self-centering clamping fixture for a high-performance thin-web gear according to claim 1, wherein the supporting column passes through a center of the spiral spring plate, the force-receiving plate is installed at the same height as a bottom portion of the right-angle push plate, two force-receiving plates are provided, and the two force-receiving plates are symmetrically mounted along a central axis of the supporting column.
